(19) United States
(12) Patent Application Publication
(10) Pub. No.: US 2021/0235718 A1
(43) Pub. Date: Aug. 5, 2021

(54) LAVER FRIED SNACK IN THREE-DIMENSIONAL SHAPE AND PREPARATION METHOD THEREFOR

(71) Applicant: Yoon Ki KIM, Seoul (KR)

(72) Inventor: Yoon Ki KIM, Seoul (KR)

(21) Appl. No.: 17/049,011

(22) PCT Filed: Apr. 19, 2019
(86) PCT No.: PCT/KR2019/004762

§ 371 Date: Oct. 19, 2020

(30) Foreign Application Priority Data
Apr. 20, 2018 (KR) 10-2018-0046005

(51) Int. Cl. A23G 3/54; A23G 3/48; A23G 3/52; A23L 13/10; A23L 17/10; A23L 19/00; A23L 23/00; A23L 29/212

(52) U.S. Cl. CPC A23G 3/54; A23G 3/48; A23G 3/52; A23L 13/10; A23G 2200/14; A23L 19/01; A23L 23/00; A23L 29/212; A23L 17/10

(57) ABSTRACT

The present invention relates to a laver fried snack in a three-dimensional shape and a preparation method therefor. Being easy to eat, the laver fried snack can be readily ingested by anyone irrespective of time and place and can be used as a side dish for meals or for alcoholic beverages. The laver fried snack can be variously configured according to tastes and needs of consumers, such as for persons reluctant to eat due to their dietary habits, or foreigners, the elderly, children, or patients and thus can be easily applied.

### TECHNICAL FIELD

The present invention relates to a laver fried snack in a three-dimensional shape and a method of producing the same, and more specifically, to a laver fried snack in a three-dimensional shape, which is easy to eat, can easily be ingested by anyone regardless of time and place, can be used as a side dish for meals or alcoholic beverages, can be prepared in various configurations according to tastes and needs of consumers, such as those who have food intake difficulty due to their dietary habits, foreigners, the elderly, children, patients, etc., and are thus easily applicable, and a method of producing the same.

### BACKGROUND ART

Laver itself is rich in nutrients and has a unique taste and flavor, but it is mostly used in the form of square laver and in the form of fried laver as a side dish.

In addition, the application of laver has been limited, merely enabling the expression of its taste a little differently by seasoning salt or some various flavors in laver.

In addition, laver could have been used only as a side dish of rice, etc. and there was a limitation on its taste to use the laver itself as a snack.

In particular, fried laver is a food consumed as a kind of side dish in the form of small powder at home or in restaurants, and it has been merely consumed at home or in restaurants, and its consumption has been limited to mealtime. Since laver and fried laver are easily broken into small pieces, their powders are blown away, etc., it is not comfortable to eat them with hands, and when laver or fried laver is eaten with hands, the residues (e.g., laver powder, oil, etc.) remain on the hands. Therefore, the use of laver or fried laver as a common snack has not been convenient.

Therefore, there is a need for the development of nutrient-rich laver with a good flavor as a snack that can be enjoyed in various ways without being limited to time or place.
(Patent Document 1) KR 10-2017-0085318 A

### DISCLOSURE OF THE INVENTION

### Technical Problem

An object of the present invention is to provide a laver fried snack in a three-dimensional shape, which is easy to use, can easily be consumed regardless of time and place, and consists of various products, allowing consumers a wide spectrum of opportunities to choose the same.

Another object of the present invention is to provide a method for producing a laver fried snack in a three-dimensional shape, which is easy to use, can easily be consumed regardless of time and place, and can be prepared in various configurations according to uses and needs.

### Technical Solution

To achieve the above objects of the present invention, the present invention provides a laver fried snack in a three-dimensional shape, which includes a core; and a shell surrounding the circumference of the core, wherein the core includes a fried laver snack core layer consisting of only a fried laver snack; and a taste layer including a food adhesive on the inside of the fried laver snack.

To achieve another object of the present invention, the present invention provides a method for producing a laver fried snack in a three-dimensional shape, which includes a first step, in which a food adhesive is rolled over fried laver, or food ingredients and a food adhesive are mixed and then rolled over fried laver, to prepare a three-dimensional core, which includes a fried laver core layer consisting of only fried laver and a taste layer including a food adhesive on the inside of the fried laver core layer; a second step, in which two semi-circular shells are prepared using grain flour or vegetable starch; and a third step, in which the core is added into any one of the semi-circular shells and is combined with another semi-circular shell to form a shell layer of a circular shape.

According to an embodiment, the present invention provides a method which further includes a fourth step in which coating is applied to the top of the circular shell layer.

According to an embodiment, the present invention provides a method, which further includes a fifth step in which a food adhesive or sauce is applied to the top of the coating layer or on top of the circular shell layer to form a cover layer.

According to an embodiment, the present invention provides a method, which, after the fifth step, may further include a sixth step in which fried laver is applied to the top of the cover layer to form a fried laver layer.

According to an embodiment, the second step may be performed using a mixture, in which fried laver is further mixed in addition to grain flour or vegetable starch.

To achieve still another object of the present invention, the present invention provides a method for producing a laver fried snack in a three-dimensional shape, which includes a first step, in which two semi-circular shells are prepared using grain flour or vegetable starch; a second step, in which a food adhesive or sauce is applied to the inside of the semi-circular shells to form a first cover layer; a third step, in which fried laver is filled into the inside of the first cover layer to form a fried laver core layer, and food ingredients and a food adhesive are filled into the inside of the fried laver core layer to form a taste layer; and a fourth step, in which the two semi-circular shells are combined to form a circular shell layer.

According to an embodiment, the method may further include a fifth step of forming a coating layer by coating on top of the circular shell layer.

The present invention provides a method for producing a laver fried snack in a three-dimensional shape, which includes a sixth step, in which a food adhesive or sauce is applied to the top of the circular shell layer to form a second cover layer; and a seventh step, in which fried laver is applied to the top of the second cover layer to form a fried laver layer.

### Advantageous Effects

The three-dimensional fried laver snack according to the present invention is portable and easy to ingest, and thus, it can easily be carried and ingested regardless of time and place, such as in the mountains, sea, in an airplane, etc.

In addition, the three-dimensional fried laver snack according to the present invention can be prepared by changing the sauces and food ingredients of the basic composition and adjusting it according to the taste of children or the elderly, thus capable of expanding the range of consumers' choices.

In addition, the three-dimensional fried laver snack according to the present invention can include vitamins, therapeutic agents, etc., and thus, can provide a therapeutic effect to patients who have lost their appetite, while allowing it to be easily ingested.

In addition, the three-dimensional fried laver snack according to the present invention may not be merely served as a kind of side dish, but its use may be expanded even to a market of snacks for alcoholic beverages, such that it may be served with conventional foods to obtain a synergistic effect.

### BRIEF DESCRIPTION OF THE DRAWINGS

FIGS. 1a to 1d are diagrams schematically illustrating cross-sections of a core prepared according to an embodiment of the present invention.

FIG. 2 is a diagram schematically illustrating a method of preparing a shell according to an embodiment of the present invention.

FIGS. 3a and 3b are cross-sectional views illustrating a shape in which a core is filled into a shell according to an embodiment of the present invention.

FIGS. 4a and 4b are cross-sectional views illustrating that a coating layer or cover layer is formed on top of a shell whose core is filled according to an embodiment of the present invention.

FIGS. 5a and 5b are cross-sectional views illustrating a laver fried snack in a three-dimensional shape according to an embodiment of the present invention.

FIGS. 6a and 6b are schematic diagrams illustrating a method for producing a laver fried snack in a three-dimensional shape according to an embodiment of the present invention.

FIGS. 7a and 7b are schematic diagrams illustrating a method for producing a laver fried snack in a three-dimensional shape according to another embodiment of the present invention.

FIG. 8 shows examples illustrating various forms of a shell.

### MODE FOR CARRYING OUT THE INVENTION

Hereinafter, embodiments of the present invention will be described in more detail.

However, these embodiments are for the illustration of the present invention, and they should not be interpreted for purpose of limitation.

According to an embodiment of the present invention, the present invention provides a laver fried snack in a three-dimensional shape, which includes a core; and a shell surrounding the circumference of the core.

According to an embodiment of the present invention, there is provided a laver fried snack in a three-dimensional shape, in which the core includes a fried laver snack core layer consisting of only a fried laver snack; and a taste layer including a food adhesive on the inside of the fried laver snack.

According to an embodiment, the taste layer is a semi-solid or solid having an adhesive property (a gel form at 1° C. to 35° C. based on room temperature), and it may be prepared as an adhesive taste layer by appropriately mixing a sticky food adhesive; by mixing a sticky food adhesive with various other food ingredients having a high viscosity (e.g., sauces, jellies, yokans, gummies, peanut butter, and shortening); or by mixing a food adhesive with agar, etc. which is a material capable of rendering a certain rigidity thereon.

In another embodiment, the taste layer may be prepared by first preparing a cake made with rice that can give a certain strength, bread made with flour, etc., a jelly made with agar, etc. followed by applying an adhesive material, which includes a food adhesive and has a high viscosity, on the outside of the taste layer.

According to an embodiment, the most common shape of the taste layer is a “spherical” shape, and the taste layer can be made in various ways along with a shell surrounding the core layer (e.g., a regular hexagon, a long cylinder, etc.) depending on the final shape of the product.

According to an embodiment, the size of the taste layer can be appropriately adjusted according to the size of the final product.

Preferably, when considering as a finger food type of product, considering that the ideal size of the product that can enter the mouth (the diameter in a spherical shape) is in a range of about 24 mm to about 28 mm, when the total core layer is in a range of 20 mm to 24 mm, which is smaller than the above range, the ideal size of the taste layer is in a range of about 4 mm to about 15 mm.

According to an embodiment, the taste layer has a texture close to that of a semi-solid or solid. However, it is possible to adjust the elasticity, strength, etc. of the taste layer according to the materials used for its preparation or the major group of consumers. For example, when the fried laver snack is produced for children or the elderly with weak teeth, the strength is prepared relatively weak, whereas when it is produced for adults to be consumed as a snack to be served with alcoholic beverages, the elasticity and strength may be further enhanced so as to give a crispy texture or hard chewing feeling.

In addition, the ingredients may be selected differentially depending on the group of consumers. For example, when targeting diet-concerned young people, the basic ingredients of the taste layer may also be prepared using agar, algae powder, etc.

According to an embodiment, as described above, the taste layer having an adhesive property may have different elasticity and viscosity depending on the group of customers, and the viscosity is preferably 1,500 Pas to 3,500 Pas at room temperature (18° C. to 30° C.). It is possible to form a fried laver core layer to be formed outside the taste layer, capable of supporting the shape of the outer surface of the snack. When the viscosity of the taste layer is too low, it is difficult to obtain the texture of the fried laver because it turns to a liquid-like phase and thus the fried laver to be applied becomes dissolved in the liquid. In contrast, when the viscosity of the taste layer is too high, the fried laver can easily be separated from the taste layer, thereby reducing the final texture.

According to an embodiment, after preparing an essential core layer (e.g., rice cake, bread, jelly, etc.) in the taste layer, an adhesive layer may be formed on the outside of the essential core layer. The adhesive strength of the adhesive layer is sufficient if the adhesive strength is very low so that the fried laver can adhere to the surface during preparation. The adhesive strength of the adhesive layer may vary depending on the temperature, but it will be sufficient if the product is not separated when stored at room temperature or at ambient temperature. For example, the adhesive strength is preferably in a range of 10 g/25 mm to 30 g/25 mm.

According to an embodiment, a coating layer surrounding the outer shell of the shell may be further included.

According to an embodiment, the coating layer may consists of one or more layers selected from the group consisting of a sugar-coating layer consisting of saccharides; a laver-coating layer consisting of laver and a food adhesive; a sugar-nut-coating layer consisting of saccharides and nuts; and a sugar-laver-coating layer consisting of saccharides and laver.

According to a fried laver snack, in which the circumference is composed of a sugar-coating layer consisting of saccharides, it has advantages in that when a user picks up a fried laver snack, the laver powder does not remain on the user's hand and it is also easy to store.

A fried laver snack consisting of a laver-coating layer, which consists of laver and a food adhesive, is good for adults who do not like sweets or those who need to avoid sugar intake.

A fried laver snack consisting of a sugar-nut-coating layer, which consists of saccharides and nuts, can ingest not only a texture but also healthy ingredients of nuts together, and thus, the snack can be used as a healthy food.

According to an embodiment, the coating layer may further include one or more kinds selected from the group consisting of nuts, dried fruits, and dried meats.

In the present invention, laver refers to food of all shapes made of laver (e.g., including fried laver) and may be preferably selected from general fried laver, fried green laver, fried stone laver, etc.

The fried laver include all the products being sold as fried laver, for example, fried laver which is roasted in oil, and fried laver which is mixed with nuts, dried shrimp, dried anchovies, dried seafood, etc.

In addition, all the products (including dried and wet products) including laver in the form of “furikake (powdered food prepared by mixing, fish powder, sesame, salt, etc., which is cut into thin slices and mixed after removing moisture without roasting in oil)”, which is not in the form of fried laver, much sold in Japan are all included in the ingredients of the present invention.

The fried laver can be used when constituting the core and can also be used for covering. The size of the fried laver used in forming the core is larger than that of the fried laver used in the covering, for example, a size in the range of about 15 mm to about 20 mm (horizontal×vertical), and a size of the fried laver used in the covering, which is in the range of about 0.1 mm to about 0.2 mm, may also be used.

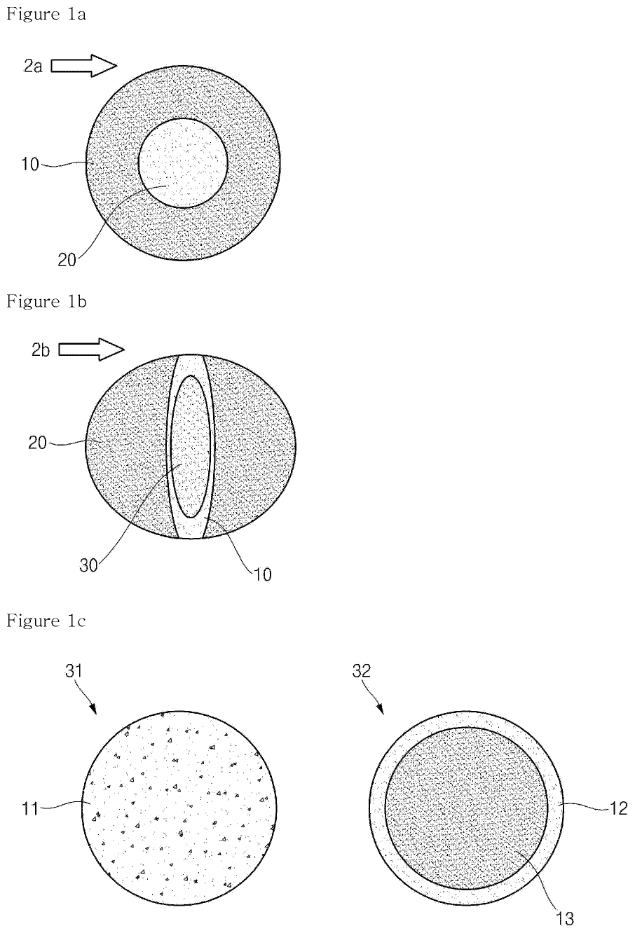

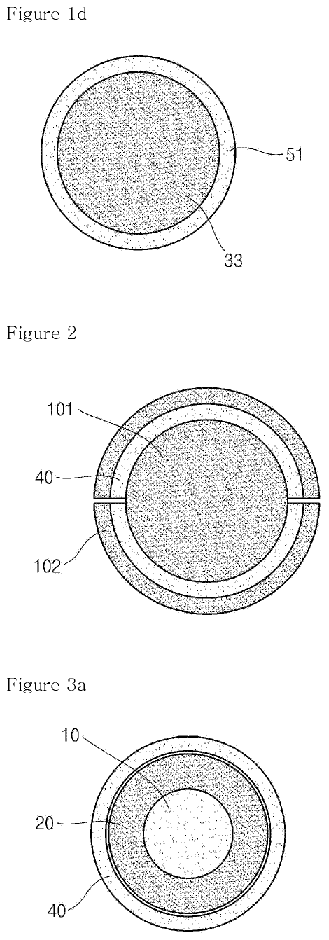

According to FIG. 1a, the core is a plain core (2a) including a taste layer that consists of a laver layer (20) and a food adhesive (10).

The food adhesive (10) may consist of starch of cereals or plants, which has no unique taste or a weak taste, or may be sauces with various flavors if a special taste is desired. The sauces may include a teriyaki sauce, a wasabi sauce, a garlic pepper sauce (Chinese style, Korean style, Southeast Asian style, etc.), a honey mustard sauce, a Vietnamese peanut sauce, a garlic butter sauce, etc. The form of the sauces is not limited, and may be used after appropriate modification by those skilled in the art in consideration of consumers' dietary habits, preferences, allergies, etc.

As the starch, one or more kinds selected from rice flour starch, corn starch, potato starch, and sweet potato starch may be used.

According to an embodiment, sugar, oligosaccharides, water, carboxymethyl cellulose (CMC: colorless, tasteless, and odorless ones extracted from micelles and red algae), etc. may be used as the food adhesive.

The taste layer may be composed to have a certain viscosity so as to constitute an integral taste layer with adhesion and elasticity by mixing food adhesives (e.g., starch, a sauce, sugar, an oligosaccharide, CMC, agar, etc.) or may be composed to have two or more layers including a certain adhesive layer and a core layer with elasticity by applying a food adhesive (e.g., starch, a sauce, sugar, etc.) to the essential core (e.g., rice, bread, jelly, etc.).

Specifically, the core may be prepared in a circular shape by mixing a fried laver and a food adhesive; the fried laver added into the frame of a “hemisphere” may be coated using an adhesive; or, the core may also be prepared in a circular shape by mixing with fried laver considering that it hardens rapidly. In addition, the core may be prepared in a circular shape by mixing nuts (e.g., pine nuts) thereto.

As an alternative method, in addition to the method of preparing the core using a sugar-based food adhesive as a food adhesive, the core may be prepared by adding it into the shell without using any food adhesive for health reasons or those who do not prefer sweets. However, the method of preparing the core using a food adhesive has advantages in that the product can be produced on a large-scale and can be preserved excellently.

According to FIG. 1b, the core is a taste core further including various foods in addition to the laver layer (20) and the food adhesive (10), and it represents a taste core (2b) including a taste layer (30), which consists of one or more kinds selected from the group consisting of nuts, dried fruits, dried fish, and dried fish in addition to laver (20).

According to FIG. 1b, although the taste layer (30) is shown separated by the laver layer (20) and the food adhesive (10), the taste layer (30) may be constituted such that laver, edible adhesives, and flavored foods may be mixed therein according to an embodiment of the present invention. For example, the taste layer may be appropriately constituted with laver and nuts; laver, a sauce, and nuts; laver and dried fruits; laver, a sauce, and dried fruits; laver and dried fish; laver, a sauce, dried fish; etc.

According to FIG. 1c, the taste layer may be prepared as an integral taste layer consisting of only a food adhesive (11); or a taste layer (32) with two or more layers consisting of a food adhesive (12), which is applied on the outside of the essential core layer (13) of rice cake, bread, cookies, etc.

According to an embodiment of the present invention, as the nuts, various nuts added to food may be used. For example, one or more kinds selected from peanuts, pistachios, cashew nuts, walnuts, pine nuts, pumpkin seeds, and sunflower seeds may be used, and nuts that match well with the selected laver may be selected.

According to an embodiment of the present invention, as the dried fruits, various dried fruits which are added to food may be used. For example, one or more kinds selected from blueberries, strawberries, grapes, cherries, mangos, apples, pears, and persimmons. The dried fruits may be selected to give the best taste depending on the kind of laver selected, and for example, raisins, dried blueberries, dried cherries, etc. may be used.

According to an embodiment of the present invention, as the dried fish, various dried fish added to food may be used. For example, one or more kinds selected from dried anchovies, dried herrings, dried sauries, and dried shrimps may be used.

According to an embodiment of the present invention, as the dried meats, various dried meats added to food may be used. For example, one or more kinds selected from dried beef, dried pork, dried chicken, and dried duck meat may be used.

According to FIG. 1d, the core may consist of a taste layer, which consists of fried laver and nuts (33), and a coating layer (51), which is coated on the outer surface of the taste layer with a sugar base. When the core is coated with a sugar layer, it can be completely sealed, thus capable of preventing rancidity of the nuts contained inside and achieving long-term storage and taste of homeostasis.

Referring to FIG. 2, the shell (40) according to an embodiment of the present invention may be prepared by mixing various kinds of grain flours (for example, grain flower (e.g., rice, unpolished rice, wheat flour, etc.) or starch powder (e.g., corn, potato, sweet potato, tapioca starch, etc.)) with water, Schisandra tea, squid ink, etc. to make a dough followed by pouring the dough between the molds (101 and 102) manufactured in a desired shape.

Specifically, according to an embodiment of the present invention, the shell may be prepared by crushing each grain, plant, etc. after steaming, adding it directly into the molds, followed by pressing and heating. For example, a shell (40) with a white rice taste may be prepared by preparing steamed white rice, adding the rice between the molds (101 and 102), and pressing and heating the rice, while adjusting the thickness of the rice.

According to another embodiment, a shell with a taste of a crust of overcooked rice may be prepared by preparing powder of a crust of overcooked rice, mixing the powder with rice, pouring the mixture between the molds (101 and 102), followed by pressing and heating.

According to still another embodiment, a shell with a shape and a taste of waffle may be prepared by preparing with a commonly used waffle base.

According to still another embodiment, a shell with a taste of potato chips or sweet potato chips may be prepared by mixing potato flour or corn flour with water to make a dough base, pouring the dough base between the molds (101 and 102), followed by pressing and heating.

A taste of baking (e.g., a crust of overcooked rice) or textures of crispy waffle, potato chips, sweet potato chips, etc. may be produced according to the heating time by slowly adjusting the thickness of the shell while pressing the same.

For example, the shell according to the present invention may be prepared in the forms of other grains or in a processed form. For example, the shell may be prepared in the form of “monaka” skin using glutinous rice or in a waffle shape using wheat flour, eggs, butter, etc. Alternatively, those which are commercially available may be purchased and used. In addition, shells of different colors may be prepared and used by mixing chocolate powder, green tea powder, laver powder, etc. with a starch base as they are commonly used in baking.

The shape and size of the shell may be determined variously according to the target consumers, uses, sales strategies, etc.

The shape of the shell, for example, as shown in FIG. 8, may be regardless of the shape and size of not only the shape of a hemisphere, but also the shape of a hexahedron or other spherical shapes, etc. and those which are commercially available may be purchased and used.

The size of the shell may be configured in various ways as needed, and the capacity of the ingredients may be determined by determining two suitable sizes, and preferably as a “one mouthful” size. For example, the size of the finished product may be in a range of 15 mm to 50 mm, and preferably 25 mm to 28 mm.

According to an embodiment, when the fried laver snack is in a circular shape, the size of the finished product may be in a range of 14 mm to 49 mm, and preferably 24 mm to 27 mm, and when the finished product consists of two or more shells, it may be appropriately modified according to the structure of layers. The finished product in a circular shape is easy to produce, and easy to eat and store, and is thus preferably used.

The thickness of the shell may be preferably in a range of 1 mm to 2 mm considering the texture and stability of the product. The thickness of the shell can be adjusted according to the mold.

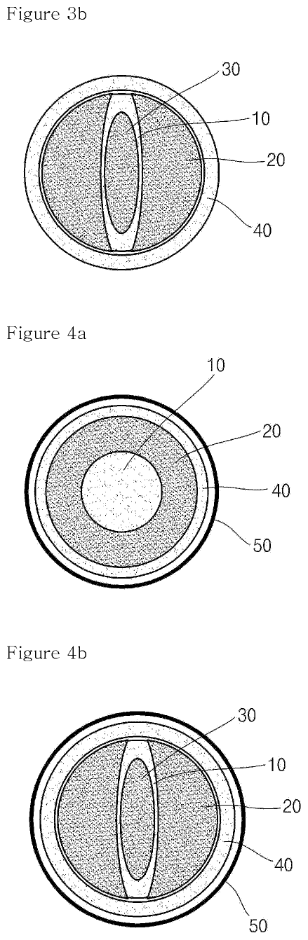

FIGS. 3a and 3b show the shapes in which the cores (2a and 2b) are included in the shell (40). According to FIG. 3a, a shape is represented in which a plain core (2a) consisting of only a laver layer (20) and a food adhesive (10) is included in the shell (40). According to FIG. 3b, a shape is represented in which the food adhesive (10) is included inside the laver layer (20), and a taste core (30), in which a taste layer (30) is included in the innermost part, is included the shell (40).

FIGS. 4a and 4b represent a cover layer (50), which is coated with a food adhesive or sauce on the outer layer of the shell (40), in which the cores (2a and 2b) are included. When a taste other than laver is not desired, only a food adhesive can be applied, whereas when various tastes are desired, selected sauces can be applied according to tastes or needs.

The cover layer (50) refers to a “layer” prepared using a food adhesive (e.g., a sugar-based food adhesive, and covering refers to a process of preparing such a film. This covering is also used to prepare a core, and has an effect of making a “film” over the shell where two “hemispheres” are combined, thereby blocking the contact with air and moisture to enable long-term storage.

In addition, products with different flavors can be prepared by adding different sauces (e.g., vinegar, a soy sauce, a wasabi sauce, a teriyaki sauce, a peanut sauce, rayu, doubanjiang, etc.) to food adhesives, in which sugar, oligosaccharides, water, and CMC are combined, which are used as a covering.

According to an embodiment, it is possible to use only a sugar-based food adhesive consisting of sugar, oligosaccharides, water, and CMC for the covering, or alternatively, it is also possible to use the sugar-based food adhesive in combination with a different product (e.g., “goguma mattang” (a combination of sweet potato, sugar, and oil) or a combination of sugar and water).

According to an embodiment of the present invention, the covering can be prepared via various combinations, for example, by coating a sugar-based edible adhesive on top of a shell; coating by mixing a sugar-based food adhesive on top of the shell with other sauces, such as those mentioned above; coating by mixing a sugar base with fried laver on top of the shell; or coating by mixing different sauces and fried laver in a sugar base on top of the shell.

For example, the covering method can also be applied in various ways by modification, by covering with a layered structure by continuously coating with other sauces after coating a food adhesive, by covering by mixing all the ingredients, by covering the mixed ingredients with a layered structure, etc. (e.g., a method of coating a food adhesive on top of the shell and then applying the fried laver and/or other sauces thereto; a method of mixing fried laver and/or other sauces on a food adhesive; a method of coating a food adhesive on top of the shell and again mixing the food adhesive with fried laver other sauces, etc.).

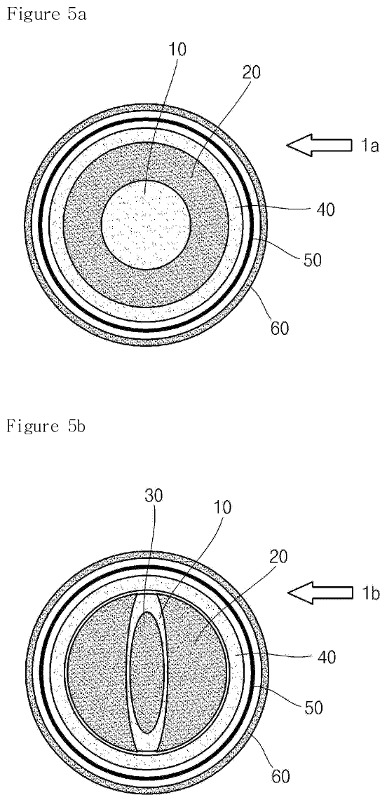

FIGS. 5a and 5b represent the cross-sections of fried laver snack (1a and 1b) according to an embodiment of the present invention. According to FIG. 5a, the fried laver snack (1a) consists of a food adhesive layer (10), a first laver layer (20), a shell (40), a cover layer (50), and a second laver layer (60). According to FIG. 5b, the fried laver snack (1b) consists of a taste layer (30), a food adhesive layer (10), a first laver layer (20), a shell (40), a cover layer (50), and a second laver layer (60).

However, the present invention is not limited thereto, and may further include various layers according to needs and tastes, such as a chocolate layer, a red pepper paste layer, and a wasabi layer between layers.

In addition, the fried laver snack can also consist of various functional snacks, by further including various health functional additives (e.g., vitamins, allergy treating agents, etc.) in the above layers. For example, the food adhesive layer (10) and the cover layer (50) may further include various additives. In addition, in order to increase the health and accessibility of children to the fried laver snack, cheese powder, chocolate powder, etc. which are favored by children, may be sprayed between layers or on the outermost shell.

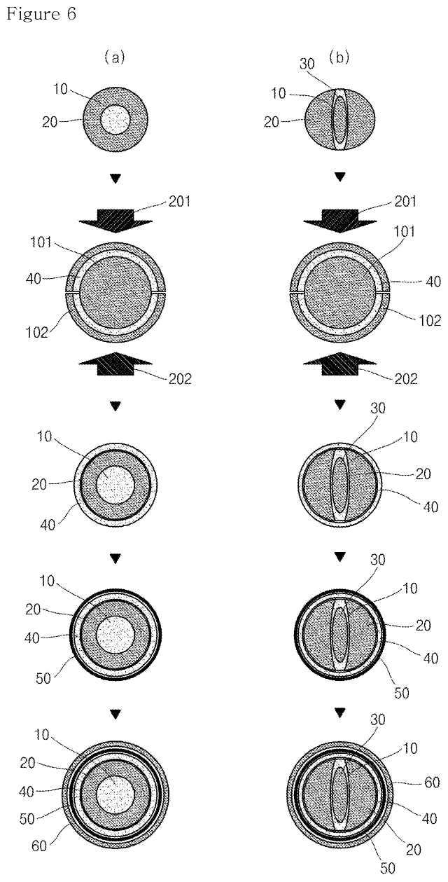

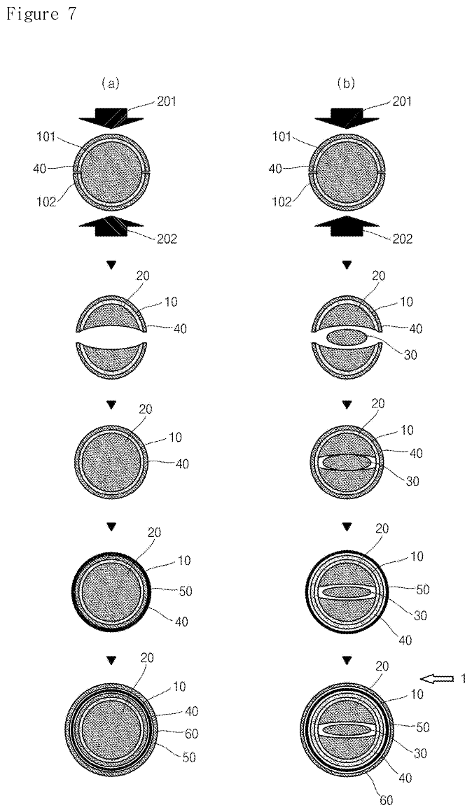

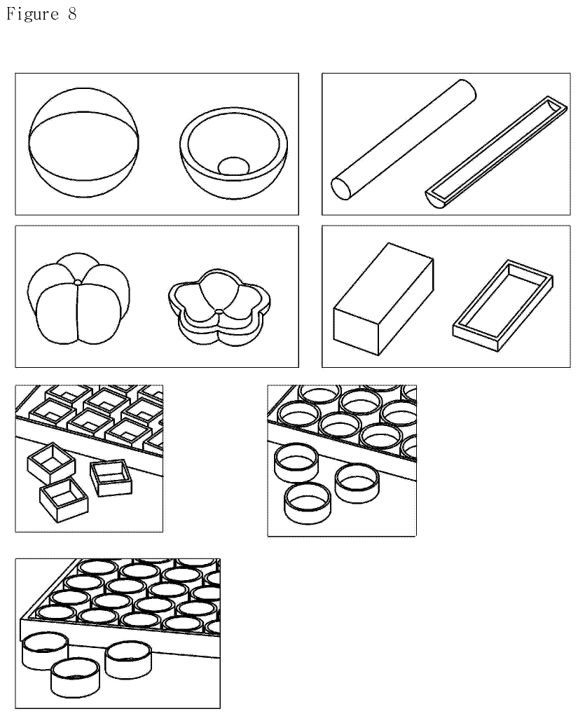

Hereinafter, a method of producing a fried laver snack according to the present invention will be described in more detail using FIGS. 6 and 7.

According to an embodiment of the present invention, as shown in FIGS. 6A and 6B, a method for preparing a laver fried snack in a three-dimensional shape is provided which includes a first step, in which a food adhesive (10) is rolled over the first laver (20), or food ingredients (30) and a food adhesive (10) are mixed and then rolled over laver (20), to prepare a three-dimensional core; a second step, in which two semi-polygonal shells (40) are prepared using grain flour or vegetable starch; a third step, in which the cores (2a and 2b) are added into any one of the semi-polygonal shells and combined with another semi-polygonal shell to form a shell layer of a polygonal shape (40); and

a fourth step, in which a coating layer is formed on top of the polygonal shell layer.

According to an embodiment, the coating layer may consist of one or more layers selected from the group consisting of a sugar-coating layer consisting of only saccharides; a laver-coating layer consisting of laver and a food adhesive; a sugar-nut-coating layer consisting of saccharides and nuts; and a sugar-laver-coating layer consisting of saccharides and laver.

According to an embodiment, a method for preparing a laver fried snack in a three-dimensional shape is provided which includes, after the fourth step, a fifth step, in which a food adhesive or sauce is applied to the top of the polygonal shells (40) to form a cover layer (50); and a sixth step, in which laver is applied to the top of the cover layer (50) to form a second laver layer (60).

The cores may be prepared with a plain core (2a), which consists of only laver (20) and a food adhesive (10), or a taste core (2b), which further includes a taste layer (30) consisting of various foods.

According to another embodiment of the present invention, a shell may be prepared first, and a fried laver snack may be prepared thereafter.

As shown in FIGS. 7A and 7B, a method for preparing a laver fried snack in a three-dimensional shape (1a, 1b, and 1c) is provided which includes a first step, in which two semi-polygonal shells (40) are prepared using grain flour or vegetable starch; a second step, in which a food adhesive or sauce is applied to the inside of the semi-polygonal shells (40) to form a food adhesive layer (10); a third step, in which fried laver (20) is filled into the inside of the first cover layer to form a core; a fourth step, in which the two semi-polygonal shells are combined to form a circular shell layer (40); and a fifth step, in which a coating layer is formed on the outside of the shell layer.

According to an embodiment, the method may include a sixth step, in which a food adhesive or sauce is applied to the top of the shell layer of a polygonal shape (40) to form a second cover layer; and a seventh step, in which second laver is applied to the top of the second cover layer to form a second laver layer (60).

The third step may further include a step of filling food ingredients or a mixture of food ingredients and a food adhesive into the inside of the first laver layer.

### Modes for Carrying Out the Invention

Hereinafter, the present invention will be described in more detail through examples. However, these examples are only for describing the present invention and should not be construed as limiting the scope of the present invention.

### Example 1

Preparation was performed according to the following sequence of preparation using the compositions shown in the following Table 1.

TABLE 1

| Constituting | | |
|---|---|---|
| Ingredients | Weight (g) | Size (mm) |
| Shell | — | 25 to 29 (length and |
| | | width are the same) |
| Pine Nuts | 0.1 to 0.2 | length (12 to 15), |
| | | width (3 to 5) |
| Food Adhesive | less than 0.1 | — |
| Fried laver (filling the | — | 15 to 20 |
| inside of shell) | | |
| Cover Layer | — | 0.2 to 0.5 |
| Fried laver (filling the | — | 0.1 to 0.2 |
| outside of shell) | | |
| Fried laver Used In | Korean Style Food | |
| Products | (CJ Bibigo),Yangban | |
| | Seaweed Paper (Dongwon), | |
| | No Brand (E Mart), | |
| | Lotte Mart | |

Sequence of Preparation

1. Fried laver was added to the inside of a prepared shell (using waffle of unpolished rice).

Fried laver was added to each of the two hemispherical shells (it is also possible to form a cover layer inside the shell).

2. Three pine nuts were added to one of the two shells which includes the fried laver (other nuts may also be used).

3. The prepared two hemispherical shells were combined together using a food adhesive.

The food adhesive used in this product was acetic acid cellulose (CMC), which is a cellulose-based material extracted from vinegar.

4. To forma cover layer in the combined spherical shape, a mixture (sugar+oligosaccharides+CMC (other coagulants may be used)+water) was heated on low heat until it melted (e.g., at about 70° C. for 5 minutes) and cooed. The sugar:oligosaccharides:CMC:water were mixed at a weight ratio of 400:100:12:45.

5. According to the preferences, it is possible to make other tastes by adding a wasabi sauce, a teriyaki sauce, a peanut sauce, etc. in addition to the oligosaccharides, sugar, and a food adhesive.

6. To the semi-product in a semispherical shape by the combination of two shells, a cover layer (oligosaccharides+sugar+a food adhesive; and a food adhesive+oligosaccharides+other sauces, when other tastes are desired) was applied, before coagulation, the mixture is rolled over finely ground fried laver to finish. The thickness was reduced while densely covering the outside of the shell by using particles with a smaller diameter than the fried laver filled into the inside.

7. The preparation was finished by aging until the food adhesive dried.

### Example 2

As a food adhesive, sodium carboxymethyl cellulose:starch of unpolished rice:wasabi sauce were mixed at a weight ratio of 1:1:0.2, and water was added thereto to a viscosity of 2,500 Pa·s at 20° C., and a taste layer of a spherical shape with a diameter of about 5 mm was prepared by adding three to four pine nuts having an average particle diameter of 4 mm into the center.

Fried laver was applied to the inside of the two prepared hemisphere-shaped shells of unpolished rice, respectively.

The sphere-shaped taste layer was added into one hemisphere-shaped shell, on which the fried laver is applied, and then covered with another shell with a hemisphere shape on which fried laver is applied. Then, the resultants were combined using a food adhesive, which was prepared by mixing sodium carboxymethyl cellulose (CMC):starch of unpolished rice:wasabi at a weight ratio of 1:1:0.01 followed by adding water to a viscosity of about 6 Pa·s.

A food adhesive was applied to the surface of the final combined sphere-shaped shell of unpolished rice and dried to prepare a laver snack with a coating layer formed thereon. The food adhesive used was prepared by mixing sugar:oligosaccharides:CMC:water at a weight ratio of 40:10:1.5:5 at low heat until it melted (at about 70° C. for 5 minutes) and cooling at room temperature.

### Example 3

As the essential core layer, a circular “injeolmi” with a diameter of 5 mm was used. The “injeolmi” was instantly immersed in an aqueous food adhesive and taken out immediately and applied to the outside of “injeolmi”. The food adhesive was prepared in an aqueous phase by mixing sodium carboxymethyl cellulose (CMC):starch of unpolished rice:bean flour at a weight ratio of 1:1:0.2 and adding water to a viscosity of about 10 Pa·s.

A laver snack was prepared by performing the subsequent procedure in the same manner as in Example 1.

### Example 4

A laver snack was prepared by performing the procedure in the same manner as in Example 2, except that the viscosity of the food adhesive constituting the taste layer was 5,000 Pa·s.

### Example 5

A laver snack was prepared by performing the procedure in the same manner as in Example 2, except that the viscosity of the food adhesive constituting the taste layer was 1,000 Pa·s.

Sensory Evaluation

Evaluation was performed using laver snacks of existing seasoned laver (i.e., (Yangban Seaweed Paper)), fried laver (Kwangcheonkim), and those prepared according to Examples 1 and 2.

A total of 30 people (10 people in their 10s or younger (Group A), 10 people in their 20s to 50s (Group B), and 10 people in their 60s or older (Group C)) were proposed to score with respect to appearance, convenience of use, taste preference, and texture out of 5 (i.e., 1: not good, 2: fair, 3: average, 4: good, and 5: very good). The average scores are shown in Table 2 below.

TABLE 2

| | Example 1 | | | Example 2 | | | Seasoned Laver | | | Fried laver | | |
|---|---|---|---|---|---|---|---|---|---|---|---|---|
| | A | B | C | A | B | C | A | B | C | A | B | C |
| Convenience | 4.0 | 4.5 | 4.7 | 4.0 | 4.5 | 4.7 | 3.0 | 3.2 | 3.5 | 2.5 | 2.5 | 2.8 |
| of Use | | | | | | | | | | | | |
| Taste | 4.4 | 4.6 | 4.8 | 4.4 | 4.8 | 4.9 | 2.5 | 3.5 | 3.6 | 1.8 | 2.0 | 2.8 |
| Preference | | | | | | | | | | | | |
| Texture | 4.7 | 4.6 | 4.6 | 4.8 | 4.8 | 4.7 | 3.5 | 3.0 | 3.0 | 2.0 | 2.2 | 2.5 |

As shown in Table 2 above, it can be seen that the evaluations with respect to convenience of use, taste, texture, etc. were all increased compared to the existing laver products through all of the generations.

Accordingly, the fried laver snack of the present invention can easily be accessed not only by people who favor laver but also young children who do not favor laver, and it is easy to carry and use. In particular, individual packaging, etc. are possible, and it is easy to ingest with only fingers. Especially, it can be used as a snack for children and adults as well as a side dish (i.e., a supplement for rice), and can be used in various ways, such as a snack for munch and alcoholic beverages as well as side dishes. In addition, the fried laver snack of the present invention consists of several layers, and a number of applications are possible by changing some ingredients of the composition of each layer. Further, it is possible to provide appropriate modification according to the circumstances of each country when exporting it to foreign countries,

TABLE 3

| | Example 2 | | | Example 4 | | | Example 5 | | |
|---|---|---|---|---|---|---|---|---|---|
| | A | B | C | A | B | C | A | B | C |
| Taste | 4.4 | 4.8 | 4.9 | 4.1 | 4.7 | 4.6 | 4.3 | 4.6 | 4.3 |
| Preference | | | | | | | | | |
| Texture | 4.8 | 4.8 | 4.7 | 4.2 | 4.0 | 4.1 | 4.0 | 4.2 | 3.9 |

In the cases of Examples 2, 4, and 5, where the preparation procedure was performed in the same manner except the viscosity of the taste layer, it can be seen that the viscosity of the taste layer of Examples 4 and 5 was either too high or too low compared to that of Example 2, and thus their textures were slightly deteriorated compared to that of Example 2.

### CODE EXPLANATION

| | |
|---|---|
| core: 2a, 2b | food adhesive: 10 |
| laver layer: 20, 60 | taste layer: 30 |
| shell: 40 | cover layer: 50 |

1. A laver fried snack in a three-dimensional shape, comprising:
a core; and a shell surrounding the circumference of the core,
wherein the core comprises a fried laver snack core layer consisting of only a fried laver snack; and a taste layer comprising a food adhesive on the inside of the fried laver snack.

2. The three-dimensional fried laver snack as claimed in claim 1, further comprising a coating layer that surrounds the circumference of the shell.

3. The three-dimensional fried laver snack as claimed in claim 2, wherein the coating layer consists of one or more layers selected from the group consisting of:
a sugar-coating layer consisting of saccharides;
a laver-coating layer consisting of laver and a food adhesive;
a sugar-nut-coating layer consisting of saccharides and nuts; and
a sugar-laver-coating layer consisting of saccharides and laver.

4. The three-dimensional fried laver snack as claimed in claim 2, wherein the coating layer further comprises one or more kinds selected from the group consisting of nuts, dried fruits, and dried meats.

5. The three-dimensional fried laver snack as claimed in claim 1, wherein the taste layer further comprises one or more kinds selected from the group consisting of nuts, dried fruits, dried fish, and dried meats.

6. The three-dimensional fried laver snack as claimed in claim 5,
wherein the food adhesive is vegetable starch or a sauce of food; and
wherein the sauce is one or more kinds selected from the group consisting of a teriyaki sauce, a wasabi sauce, a garlic pepper sauce, a honey mustard sauce, a Vietnamese peanut sauce, and a garlic butter sauce.

7. The three-dimensional fried laver snack as claimed in claim 5, wherein the nuts are one or more kinds selected from the group consisting of peanuts, pistachios, cashew nuts, walnuts, pine nuts, pumpkin seeds, and sunflower seeds.

8. The three-dimensional fried laver snack as claimed in claim 5, wherein the dried fruits are one or more kinds selected from the group consisting of dried blueberries, dried strawberries, dried grapes, dried cherries, dried mangos, dried apples, dried pears, and dried persimmons.

9. The three-dimensional fried laver snack as claimed in claim 5, wherein the dried fish is one or more kinds selected from the group consisting of dried anchovies, dried herrings, dried sauries, and dried shrimps.

10. The three-dimensional fried laver snack as claimed in claim 5, wherein the dried meats are one or more kinds selected from the group consisting of dried beef, dried pork, dried chicken, and dried duck meat.

11. The three-dimensional fried laver snack as claimed in claim 1, wherein the shell consists of grain flour or vegetable starch.

12. The three-dimensional fried laver snack as claimed in claim 1, wherein the shell has a shape of crust of overcooked rice or a shape of a waffle.

13. The three-dimensional fried laver snack as claimed in claim 6, wherein the vegetable starch is one or more kinds selected from the group consisting of rice flour starch, corn starch, potato starch, and sweet potato starch.

14. A method for producing a laver fried snack in a three-dimensional shape, comprising:
a first step, in which a food adhesive is rolled over fried laver, or food ingredients and a food adhesive are mixed and then rolled over fried laver, to prepare a three-dimensional core, which comprises a fried laver core layer consisting of only fried laver and a taste layer comprising a food adhesive on the inside of the fried laver core layer;
a second step, in which two semi-polygonal shells are prepared using grain flour or vegetable starch;
a third step, in which the core is added into any one of the semi-polygonal shells and is combined with another semi-polygonal shell to form a shell layer of a polygonal shape; and
a fourth step, in which a coating layer is formed on top of the polygonal shell layer.

15. The method for producing a laver fried snack in a three-dimensional shape as claimed in claim 14, wherein the coating layer consists of one or more layers selected from the group consisting of:
a sugar-coating layer consisting of saccharides;
a fried laver-coating layer consisting of fried laver and a food adhesive;
a sugar-nut-coating layer consisting of saccharides and nuts; and
a sugar-laver-coating layer consisting of saccharides and laver.

16. The method for producing a laver fried snack in a three-dimensional shape as claimed in claim 15, wherein, after the fourth step, the method further comprising:
a fifth step, in which a food adhesive or sauce is applied to form a cover layer; and
a sixth step, in which fried laver is applied to the top of the cover layer to form a fried laver layer.

17. A method for producing a laver fried snack in a three-dimensional shape, comprising:
a first step, in which two semi-polygonal shells are prepared using grain flour or vegetable starch;
a second step, in which a food adhesive or sauce is applied to the inside of the semi-polygonal shells to form a first cover layer;
a third step, in which fried laver is filled into the inside of the first cover layer to form a fried laver core layer, and food ingredients and a food adhesive are filled into the inside of the fried laver core layer to form a taste layer;
a fourth step, in which the two semi-polygonal shells are combined to form a shell layer of a polygonal shape; and
a fifth step, in which a coating layer is formed on the outside of the shell layer.

18. The method for producing a laver fried snack in a three-dimensional shape as claimed in claim 17, wherein, after the fifth step, the method further comprising:
a sixth step, in which a food adhesive or sauce is applied to the top of the shell layer of a polygonal shape to form a second cover layer; and
a seventh step, in which laver is applied to the top of the second cover layer to form a laver layer.

19. The three-dimensional fried laver snack as claimed in claim 11, wherein the vegetable starch is one or more kinds selected from the group consisting of rice flour starch, corn starch, potato starch, and sweet potato starch.
